(19) United States
(12) Patent Application Publication
(10) Pub. No.: US 2008/0180079 A1
(43) Pub. Date: Jul. 31, 2008

(54) Voltage regulator

(76) Inventors: Tadashi Kurozo, Chiba-shi (JP); Kiyoshi Yoshikawa, Chiba-shi (JP); Fumiyasu Utsunomiya, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 11/998,386

(22) Filed: Nov. 29, 2007

(30) Foreign Application Priority Data
Dec. 8, 2006 (JP) 2006-332088

(51) Int. Cl. G05F 1/08; G05F 1/20; G05F 1/46

(52) U.S. Cl. 323/284

(57) ABSTRACT

A voltage regulator according to the present invention is operated stably. Regardless of a condition of a load (25), a variation in drain voltage of a PMOS transistor (34) is made equal to a variation in output voltage (Vout) at an output terminal of the voltage regulator. Then, a variation in voltage which is equal to the variation in output voltage (Vout) at the output terminal which is caused by a change of the condition of the load (25) is fed back to an error amplifier (70), so a gain of a signal for phase compensation which is fed back to the error amplifier (70) is determined based on the output voltage (Vout). Therefore, even when the condition of the load (25) changes, the behavior of phase compensation is correct.

### BACKGROUND OF THE INVENTION

1. Field of the Invention

The present invention relates to a voltage regulator including a phase compensation circuit.

2. Description of the Related Art

In recent years, an electronic device containing a voltage regulator has been improved in performance. Therefore, a maximum output current of the voltage regulator tends to increase, so a large parasitic capacitance is caused by a gate of an output transistor. A minimum output current of the voltage regulator tends to decrease, so a load resistance increases. The current consumption of the voltage regulator reduces to increase an output resistance of an error amplifier of the voltage regulator.

As a result, it is more likely to cause a pole at a low frequency range in a characteristic of a system amplified and negative-fed back by the error amplifier and the output transistor, so a footprint of a phase compensation circuit of the voltage regulator becomes larger.

A technology disclosed in JP 2005-316788 A has been known for a voltage regulator containing a phase compensation circuit having preferable area efficiency. FIG. 6 is a schematic circuit diagram showing a conventional voltage regulator.

An output of an error amplifier 70 is connected with a common-source amplifying circuit including a PMOS transistor 71 and a resistor element 73. An output signal from the common-source amplifying circuit is fed back to the error amplifier 70 through a capacitor 72. The capacitor 72 acts as a capacitor component larger in capacitance than an actual capacitor component because of a mirror effect, so the footprint can be reduced.

An output signal from the error amplifier 70 is a control signal for holding an output voltage Vout at an output terminal of the voltage regulator to a constant voltage. Therefore, when drain output resistances of the PMOS transistor 71 and a PMOS transistor 74 which are controlled by the error amplifier 70 are different from each other, a drain voltage of the PMOS transistor 71 is not held to a constant voltage and thus changes according to a load condition.

As a result, a variation in voltage which is different from a variation in output voltage Vout at the output terminal of the voltage regulator is fed back to the error amplifier 70, so the behavior of phase compensation is incorrect. Thus, it is likely to cause oscillation, thereby making the operation of the voltage regulator unstable.

### SUMMARY OF THE INVENTION

The present invention has been made in view of the above-mentioned problems. An object of the present invention is to provide a voltage regulator which can be operated stably.

In order to solve the above-mentioned problems, the present invention provides a voltage regulator including a phase compensation circuit, for outputting a voltage controlled to a constant value from an output terminal to a load, characterized by including: a reference voltage circuit; a voltage dividing circuit provided between the output terminal and a ground; an error amplifier having a first terminal connected with an output of the reference voltage circuit and a second terminal connected with an output of the voltage dividing circuit; a first transistor having a gate connected with an output of the error amplifier and a source connected with a power supply; an output transistor having a gate connected with the output of the error amplifier, a source connected with the power supply, and a drain connected with the output terminal; a second transistor having a source connected with a drain of the first transistor; a third transistor having a source connected with the output terminal and a gate and a drain connected with each other, the gate of the third transistor being connected with a gate of the second transistor; a resistor element provided between a drain of the second transistor and the ground; a constant current source provided between the drain of the third transistor and the ground; and a capacitor provided between the drain of the first transistor and the output of the voltage dividing circuit.

According to the present invention, regardless of a load condition, a variation in drain voltage of the first transistor is equal to a variation in output voltage at the output terminal. Therefore, a variation in voltage which is equal to the variation in output voltage at the output terminal which is caused by a change in the load condition is fed back to the error amplifier, so a gain of a signal for phase compensation which is fed back to the error amplifier is determined based on the output voltage. Thus, even when the load condition changes, the behavior of phase compensation is correct.

### BRIEF DESCRIPTION OF THE DRAWINGS

In the accompanying drawings:

FIG. 1 is a circuit diagram showing a voltage regulator according to an embodiment of the present invention;

FIG. 2 is a circuit diagram showing another example of the voltage regulator according to the embodiment of the present invention;

FIG. 3 is a circuit diagram showing another example of the voltage regulator according to the embodiment of the present invention;

FIG. 4 is a circuit diagram showing another example of the voltage regulator according to the embodiment of the present invention;

FIG. 5 is a circuit diagram showing another example of the voltage regulator according to the embodiment of the present invention; and

FIG. 6 is a circuit diagram showing a conventional voltage regulator.

### DETAILED DESCRIPTION OF THE PREFERRED EMBODIMENT

Hereinafter, a voltage regulator according to an embodiment of the present invention will be described in detail with reference to the attached drawings.

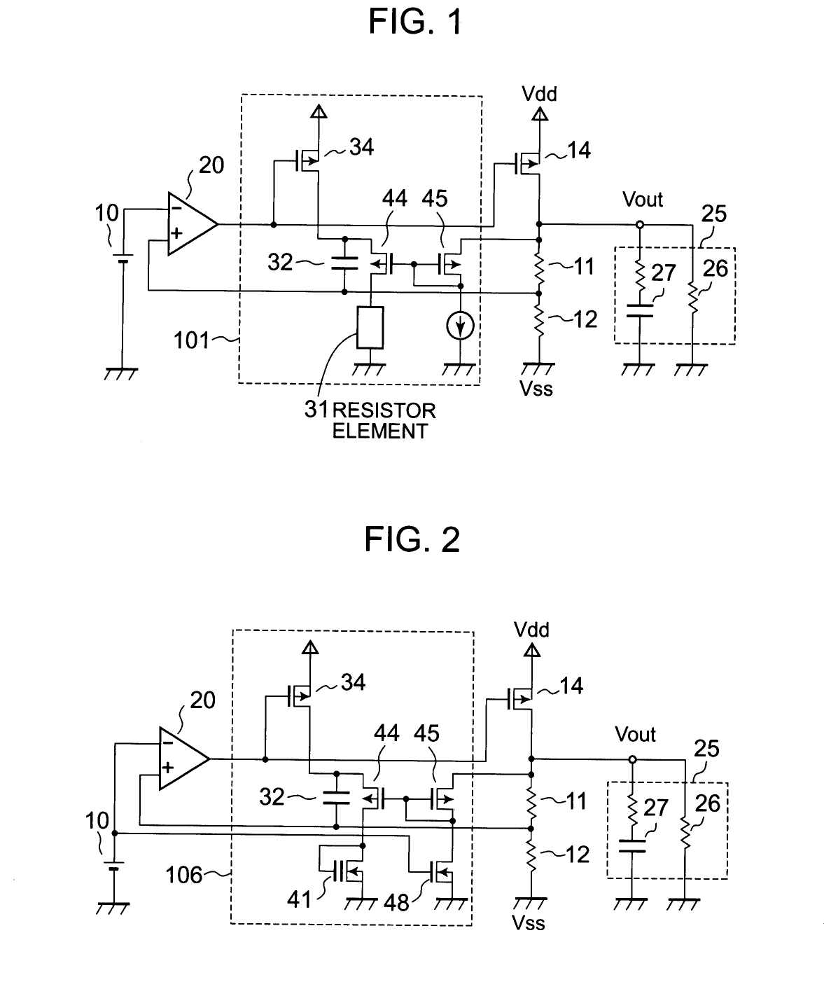

FIG. 1 is a circuit diagram showing the voltage regulator according to the embodiment of the present invention.

The voltage regulator includes a reference voltage circuit 10, an error amplifier 20, an output transistor 14, bleeder resistors 11 and 12, and a phase compensation circuit 101. The phase compensation circuit 101 includes PMOS transistors 34, 44, and 45, a capacitor 32, a resistor element 31, and a constant current source 47.

In the voltage regulator, the PMOS transistor 34 has a gate connected with an output of the error amplifier 20 and a source connected with a power supply. The output transistor 14 has a gate connected with the output of the error amplifier 20, a source connected with a power supply, and a drain connected with an output terminal of the voltage regulator. The PMOS transistor 44 has a gate connected with a gate of the PMOS transistor 45 and a source connected with drain of the PMOS transistor 34. The PMOS transistor 45 has a source connected with the output terminal of the voltage regulator and a gate and a drain which are connected with each other. The resistor element 31 is provided between a drain of the PMOS transistor 44 and a ground. The constant current source 47 is provided between the drain of the PMOS transistor 45 and the ground. The bleeder resistors 11 and 12 are provided between the output terminal of the voltage regulator and the ground. The capacitor 32 is provided between the drain of the PMOS transistor 34 and a connection point between the bleeder resistors 11 and 12. The error amplifier 20 has an inverted input terminal connected with an output of the reference voltage circuit 10 and a non-inverted input terminal connected with the connection point between the bleeder resistors 11 and 12.

Next, the operation of the voltage regulator will be described.

The output transistor 14 generates an output voltage Vout. The output voltage Vout is divided by the bleeder resistors 11 and 12 which act as a voltage dividing circuit. The error amplifier 20 compares an output voltage of the voltage dividing circuit with an output voltage of the reference voltage circuit 10 and controls to make the output voltage of the voltage dividing circuit equal to the output voltage of the reference voltage circuit 10. The phase compensation circuit 101 compensates for a phase of the voltage regulator.

A power supply voltage Vdd of the power supply which is an input voltage is inputted to the voltage regulator. Then, the output transistor 14 performs a predetermined operation to generate the output voltage Vout adjusted to a constant voltage. The output voltage Vout is divided by the bleeder resistors 11 and 12 which act as the voltage dividing circuit. When the output voltage of the voltage dividing circuit becomes lower (output voltage Vout at the output terminal of the voltage regulator becomes lower), the output voltage of the error amplifier 20 reduces. Then, the output transistor 14 is turned on to reduce an on-resistance of the output transistor 14. Therefore, the output voltage Vout becomes higher. On the other hand, when the output voltage of the voltage dividing circuit becomes higher (output voltage Vout at the output terminal of the voltage regulator becomes higher), the output voltage of the error amplifier 20 increases. Then, the output transistor 14 is turned off to increase the on-resistance of the output transistor 14. Therefore, the output voltage Vout becomes lower. Thus, the output voltage Vout at the output terminal of the voltage regulator is adjusted to a constant value.

A zero point Fz1 is formed by the capacitor 32, the bleeder resistors 11 and 12, the PMOS transistors 34 and 44, and the resistor element 31. A first pole Fp1 is formed by an output resistor of the error amplifier 20 and a gate capacitor of the output transistor 14. A second pole Fp2 is formed by a load resistor 26 and an output capacitor 27. Therefore, when the circuit is designed such that the zero point Fz1 appears at a lower frequency than the first pole Fp1 and the second pole Fp2, the voltage regulator operates stably.

The PMOS transistors 44 and 45 are connected in a current mirror configuration. A voltage equal to the output voltage Vout at the output terminal of the voltage regulator is caused at the drain of the PMOS transistor 34 by the PMOS transistors 44 and 45, the resistor element 31, and the constant current source 47. Therefore, regardless of a condition of a load 25, a variation in voltage (signal for phase compensation) obtained by amplifying the output voltage of the error amplifier 20 by the PMOS transistor 34 is equal to a variation in output voltage Vout obtained by amplifying the output voltage of the error amplifier 20 by the output transistor 14.

The output signal of the error amplifier 20 is fed back to the error amplifier 20 through the PMOS transistor 34 and the capacitor 32. In addition, the output signal of the error amplifier 20 is fed back to the error amplifier 20 through the output transistor 14 and the resistor 11. Further, the output signal of the error amplifier 20 is fed back to the error amplifier 20 through the output transistor 14, the PMOS transistor 45, the PMOS transistor 44, and the capacitor 32. At this time, because of the gate capacitor of the output transistor 14, the feedback through the PMOS transistor 34 is faster than the feedback through the output transistor 14.

According to such a structure, regardless of the condition of the load 25, a variation in drain voltage (signal for phase compensation) of the PMOS transistor 34 is equal to a variation in output voltage Vout at the output terminal (drain voltage of the output transistor 14) of the voltage regulator. Therefore, a variation in voltage which is equal to the variation in output voltage Vout at the output terminal of the voltage regulator which is caused by a change of the condition of the load 25 is fed back to the error amplifier 20, so a gain of the signal for phase compensation which is fed back to the non-inverted input terminal of the error amplifier 20 is determined based on the output voltage Vout. Thus, even when the condition of the load 25 changes, the behavior of phase compensation is correct, with the result that the frequency of oscillation reduces to stabilize the operation of the voltage regulator. Because the gain of the signal for phase compensation is correctly determined based on the output voltage Vout, there is no case where the gain reduces to unnecessarily delay a phase or the gain increases to unnecessarily advance the phase.

Further, because the variation in drain voltage (signal for phase compensation) of the PMOS transistor 34 is equal to the variation in output voltage Vout at the output terminal (drain voltage of the output transistor 14) of the voltage regulator regardless of the condition of the load 25, the PMOS transistor 34 and the output transistor 14 can be normally continuously operated as a current mirror circuit. Therefore, even when the output transistor 14 is completely turned on, the PMOS transistor 34 allows a current-based on the current of the output transistor 14 to flow. Thus, an unnecessary current does not flow through the PMOS transistor 34, so the current consumption of the voltage regulator becomes smaller.

The capacitor 32 acts as a capacitor component larger in capacitance than an actual capacitor component because of a mirror effect of a common-source amplifying circuit including the error amplifier 20 and the PMOS transistor 34, so the footprint can be reduced. For example, when an amplification factor is ten times, the capacitor 32 acts as a capacitor component which is ten times larger in capacitance than an actual capacitor component and thus the footprint of the capacitor 32 may be reduced by a factor of 10.

Next, examples of the resistor element 31 and the constant current source 47 in the voltage regulator according to the embodiment of the present invention will be described with reference to FIG. 2.

The resistor element 31 includes an NMOS transistor 41 having a gate and a drain connected with the drain of the PMOS transistor 44 and a source connected with the ground. The NMOS transistor 41 has a current drive capability capable of releasing all the current flowing into the PMOS transistor 34 to the ground when an output current is maximum.

The constant current source 47 includes an NMOS transistor 48 having a drain connected with the drain of the PMOS transistor 45, a gate connected with the output of the reference voltage circuit 10, and a source connected with the ground. The current consumption of each of the PMOS transistors 44 and 45 and the NMOS transistors 41 and 48 is determined based on a circuit constant of the NMOS transistor 48.

According to such a structure, a novel bias circuit is unnecessary for the constant current source 47, so the current consumption of the voltage regulator becomes smaller.

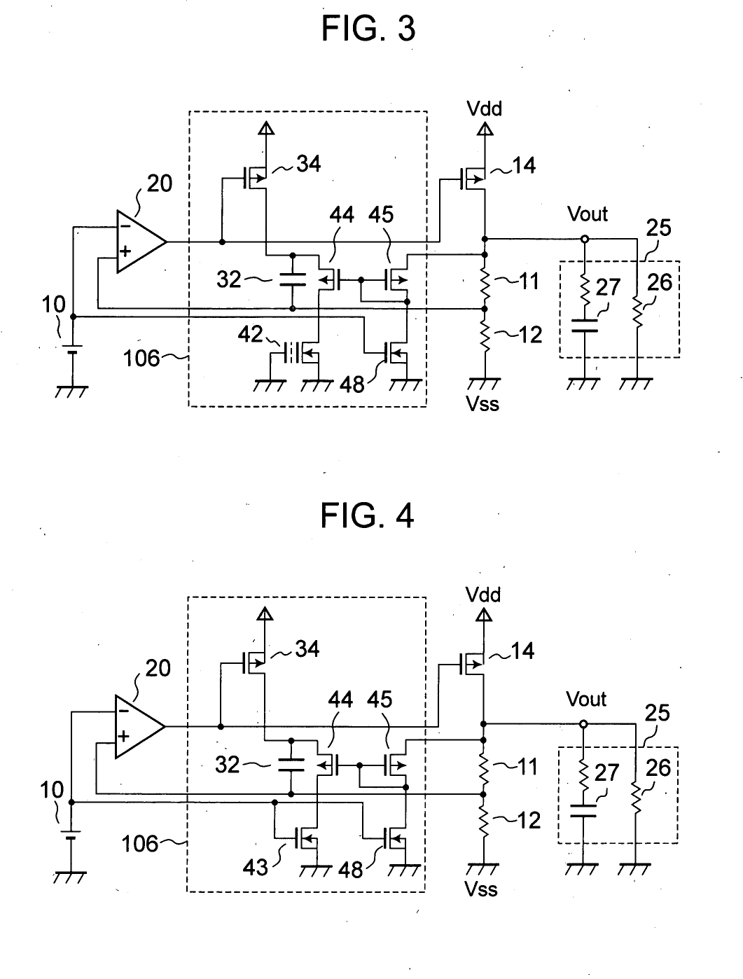

Next, other examples of the resistor element 31 and the constant current source 47 in the voltage regulator according to the embodiment of the present invention will be described with reference to FIG. 3.

The resistor element 31 includes an NMOS (depletion) transistor 42 having a drain connected with the drain of the PMOS transistor 44 and a gate and a source connected with the ground.

The constant current source 47 includes the NMOS transistor 48.

Next, other examples of the resistor element 31 and the constant current source 47 in the voltage regulator according to the embodiment of the present invention will be described with reference to FIG. 4.

The resistor element 31 includes an NMOS transistor 43 having a drain connected with the drain of the PMOS transistor 44, a gate connected with the output of the reference voltage circuit 10, and a source connected with the ground.

The constant current source 47 includes the NMOS transistor 48.

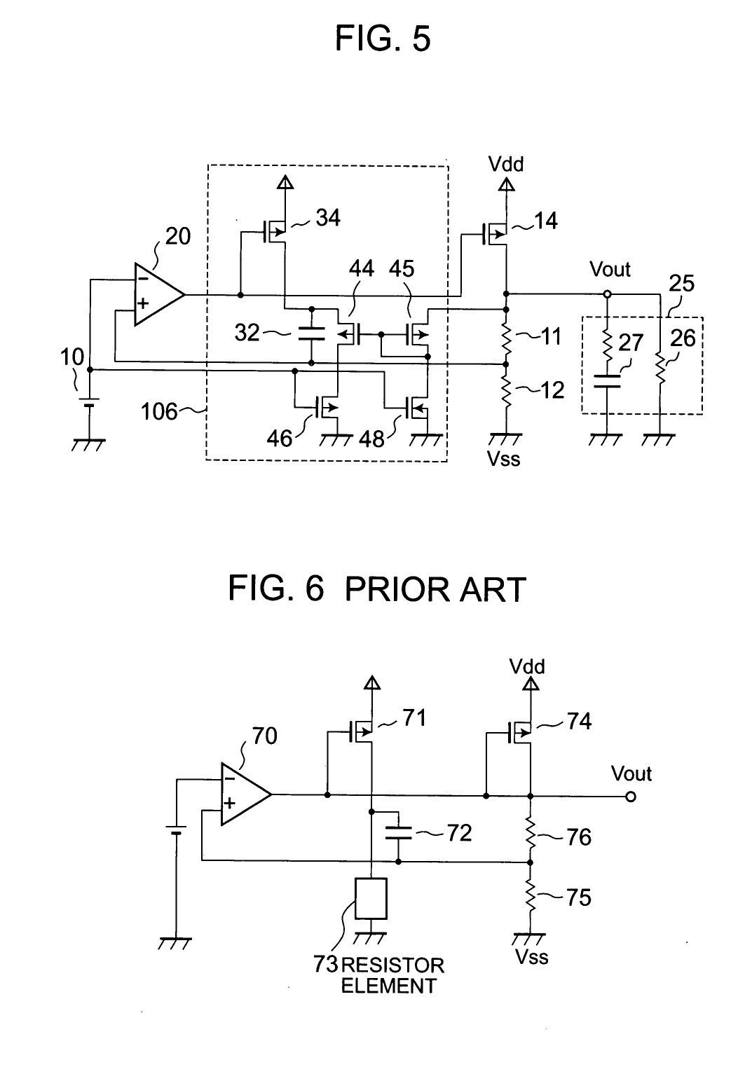

Next, other examples of the resistor element 31 and the constant current source 47 in the voltage regulator according to the embodiment of the present invention will be described with reference to FIG. 5.

The resistor element 31 includes a PMOS transistor 46 having a source connected with the drain of the PMOS transistor 44, a gate connected with the output of the reference voltage circuit 10, and a drain connected with the ground.

The constant current source 47 includes the NMOS transistor 48.

What is claimed is:

1. A voltage regulator including a phase compensation circuit, for outputting a voltage controlled to a constant value from an output terminal to a load, comprising:
a reference voltage circuit;
a voltage dividing circuit provided between the output terminal and a ground;
an error amplifier having a first terminal connected with an output of the reference voltage circuit and a second terminal connected with an output of the voltage dividing circuit;
a first transistor having a gate connected with an output of the error amplifier and a source connected with a power supply;
an output transistor having a gate connected with the output of the error amplifier, a source connected with the power supply, and a drain connected with the output terminal;
a second transistor having a source connected with a drain of the first transistor;
a third transistor having a source connected with the output terminal and a gate and a drain connected with each other, the gate of the third transistor being connected with a gate of the second transistor;
a resistor element provided between a drain of the second transistor and the ground;
a constant current source provided between the drain of the third transistor and the ground; and
a capacitor provided between the drain of the first transistor and the output of the voltage dividing circuit.

2. A voltage regulator according to claim 1, wherein the constant current source includes a first NMOS transistor having a drain connected with the drain of the third transistor, a gate connected with the output of the reference voltage circuit, and a source connected with the ground.

3. A voltage regulator according to claim 1, wherein the resistor element includes a second NMOS transistor having a gate and a drain connected with the drain of the second transistor, and a source connected with the ground.

4. A voltage regulator according to claim 1, wherein the resistor element includes a depletion NMOS transistor having a drain connected with the drain of the second transistor, and a gate and a source connected with the ground.

5. A voltage regulator according to claim 1, wherein the resistor element includes a third NMOS transistor having a drain connected with the drain of the second transistor, a gate connected with the output of the reference voltage circuit, and a source connected with the ground.

6. A voltage regulator according to claim 1, wherein the resistor element includes a first PMOS transistor having a source connected with the drain of the second transistor, a gate connected with the output of the reference voltage circuit, and a drain connected with the ground.
